(19) United States
(12) Patent Application Publication
(10) Pub. No.: US 2012/0299311 A1
(43) Pub. Date: Nov. 29, 2012

(54) ORGANIC RANKINE CYCLE (ORC) LOAD FOLLOWING POWER GENERATION SYSTEM AND METHOD OF OPERATION

(75) Inventors: Bruce P. Biederman, Old Greenwich, CT (US); Frederick J. Cogswell, Glastonbury, CT (US); Ulf J. Jonsson, South Windsor, CT (US); Robert K. Thornton, Coventry, CT (US)

(73) Assignee: UNITED TECHNOLOGIES CORPORATION, Hartford, CT (US)

(21) Appl. No.: 13/575,685

(22) PCT Filed: Jan. 27, 2010
(86) PCT No.: PCT/US10/22204

§ 371 Date: Jul. 27, 2012

(51) Int. Cl. F01D 15/10; H02J 7/34; H02P 9/04

(52) U.S. Cl. 290/40 B; 290/52; 290/50

(57) ABSTRACT

A system for producing power using an organic Rankine cycle (ORC) includes a turbine, a generator, an evaporator, an electric heater, an inverter system and an organic Rankine cycle (ORC) voltage regulator. The turbine is coupled to the generator for producing electric power. The evaporator is upstream of the turbine and the electric heater is upstream of the evaporator. The evaporator provides a vaporized organic fluid to the turbine. The electric heater heats the organic fluid prior to the evaporator. The inverter system is coupled to the generator. The inverter system transfers electric power from the generator to a load. The ORC voltage regulator is coupled to the inverter system and to the electric heater and it diverts excess electrical power from the inverter system to the electric heater.

### BACKGROUND

Rankine cycle systems are commonly used for generating electrical power. The Rankine cycle system includes an evaporator or a boiler for evaporation of a working fluid, a turbine that receives the vapor from the evaporator to drive a generator, a condenser for condensing the vapor, and a pump or other means for recycling the condensed fluid to the evaporator. The working fluid in Rankine cycle systems is often water, and the turbine is thus driven by steam. An organic Rankine cycle (ORC) system operates similarly to a traditional Rankine cycle, except that an ORC system uses an organic fluid, instead of water, as the working fluid. Some organic fluid vaporizes at a lower temperature than water, allowing a low temperature heat source such as industrial waste heat, biomass heat, geothermal heat and solar thermal heat to be used as the heat source to the evaporator.

In some situations, after the power is generated by the ORC system, it flows through an inverter system to either a load or a grid. The inverter system includes a DC bus that must be maintained at a near-constant voltage. Typically, the ORC system is connected to an infinite grid, which accepts all of the power generated by the ORC system and maintains a constant voltage on the DC bus. However, it is desirable to use an ORC system to generate power in remote areas or other locations where an infinite grid is not available. When an infinite grid is not available, the flow of power into the DC bus must follow the load in order to maintain a constant voltage on the DC bus.

### SUMMARY

A system for producing power using an organic Rankine cycle (ORC) includes a turbine, a generator, an evaporator, an electric heater, an inverter system and an ORC voltage regulator. The turbine is coupled to the generator for producing electric power. The evaporator is upstream of the turbine and the electric heater is upstream of the evaporator. The evaporator provides a vaporized organic fluid to the turbine. The electric heater heats the organic fluid prior to the evaporator. The inverter system is coupled to the generator. The inverter system transfers electric power from the generator to a load. The ORC voltage regulator is coupled to the inverter system and to the electric heater and it diverts excess electrical power from the inverter system to the electric heater.

### BRIEF DESCRIPTION OF THE DRAWINGS

FIG. 1 is a schematic of an organic Rankine cycle (ORC) power generation system designed to divert excess electrical power from an inverter system back to an organic Rankine cycle (ORC) system.

FIG. 2 is schematic of a power generation system similar to FIG. 1 and further including a parasitic load for the ORC system.

FIG. 3 is an enlarged schematic view of the power generation system of FIG. 2 in steady-state mode illustrating the power at selected points in the system.

FIG. 4 is a schematic view of the power generation system of FIG. 3 immediately following a positive step change in a load.

FIG. 5 is a schematic view of the power generation system of FIG. 4 after the power generation system has entered steady-state mode following the positive step change.

FIG. 6 is a schematic view of the power generation system of FIG. 3 immediately following a negative step change in a load.

FIG. 7 is a schematic view of the power generation system of FIG. 6 in stand-by mode awaiting re-connection to a grid.

### DETAILED DESCRIPTION

A Rankine cycle system may be used to generate electrical power. The Rankine cycle uses a vaporized working fluid (i.e. water) to drive a generator that produces electrical power. An organic Rankine cycle (ORC) operates similar to a traditional Rankine cycle, except that an ORC system uses an organic fluid, instead of water, as the working fluid, so that the ORC system can use a lower temperature heat source for evaporation of the working fluid. Example lower temperature heat sources include industrial waste heat, biomass heat (such as trees), geothermal heat, solar thermal heat.

After electric power is produced by the generator, the power flows through an inverter system to a grid or a load. The inverter system includes a DC bus that must be maintained at a near-constant voltage. Equal power must flow into and out of the DC bus in order to maintain a constant voltage on the DC bus. When the ORC system is connected to an infinite grid, excess generated power is exported to the infinite grid and the voltage of the DC bus is maintained. However, when the ORC system is used in a remote area or other location where an infinite grid is not available, the inverter system must pump more or less power to maintain the voltage of the DC bus in response to changes in the load. For example, when a user turns on a light, more power flows out of the DC bus than flows into the DC bus, causing the DC bus voltage to drop, and the power into the DC bus must be increased to maintain the DC bus voltage. Similarly, when a user turns off the light, more power flows into the DC bus than flows out of the DC bus, which causes the DC bus voltage to increase, and the power into the DC bus must be decreased to maintain the DC bus voltage. The power generation system must act to maintain the DC bus voltage within acceptable limits. One way to maintain a constant DC bus voltage is to adjust the amount of power generated by the ORC system. However, the electric power generated by an ORC system cannot be quickly controlled as will be described further below. The inverter system provides a capacitance between milliseconds and one second for voltage adjustment of the DC bus while it takes minutes to adjust the amount of power generated by the ORC system. The system and method described herein include generating and diverting excess electric back to the ORC system so that a constant voltage is maintained on the DC bus during positive and negative step changes in load when an infinite grid is not available. This system and method quickly change the power to DC bus, creating a load-following ORC power generation system and allowing the ORC system to be used without an infinite grid.

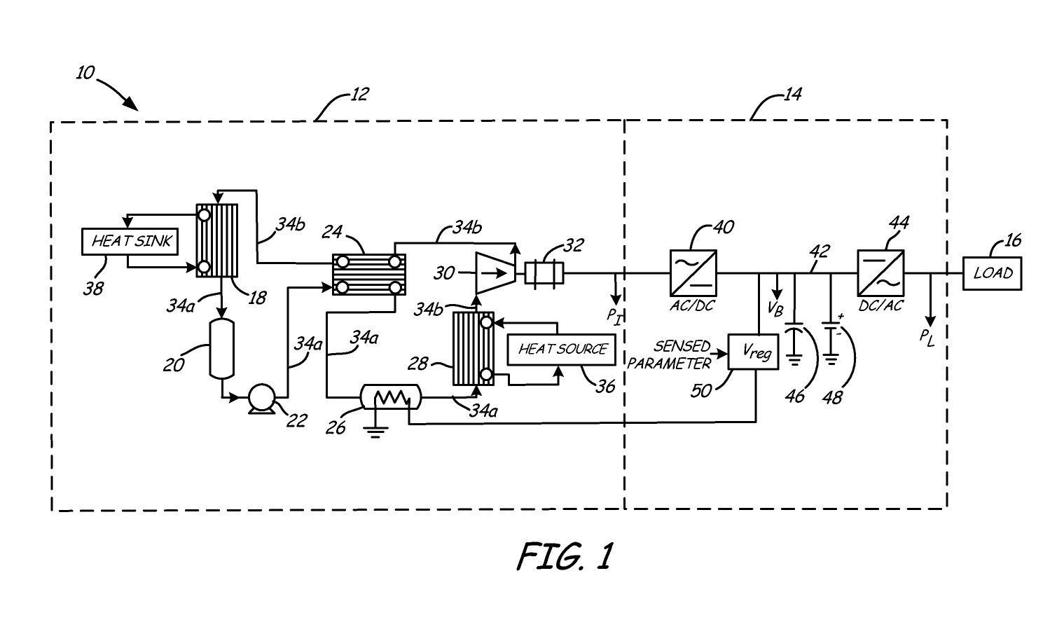

FIG. 1 is a schematic of power system 10 having organic Rankine cycle (ORC) power generation system 12, inverter or power electronics system 14 and load 16. Electric power generated by ORC system 12 flows through inverter system 14 to load 16. Load 16 can be part of a local grid or an island grid. ORC system 12 is not connected to an infinite grid. Therefore, power in excess of load 16 cannot be exported to an infinite grid, and power system 10 must be able to follow changes in load 16.

ORC system 12 includes condenser 18, reservoir 20, pump 22, recuperator 24, electric heater 26, evaporator 28, turbine 30 and generator 32. Organic working fluid 34 circulates through a closed loop in ORC system 12 and is used to generate electric power. Receiver or reservoir 20 stores liquid working fluid 34a from condenser 18 upstream of pump 22. Receiver 20 provides stability to ORC system 12 by providing a source of liquid working fluid 34a upstream of pump 22 and preventing vapor from entering pump 22. Although receiver 20 is illustrated in FIG. 1 as a separate structure, receiver 20 can be integrated with condenser 18. For example, condenser 18 can be a water-cooled condenser, which performs the functions of a condenser and a receiver.

Liquid working fluid 34a is fed from receiver 20 to pump 22. Pump 22 increases the pressure of liquid working fluid 34a. High pressure liquid fluid 34a then flows through recuperator 24 and electric heater 26 to evaporator 28. Recuperator 24 and heater 26 heat working fluid 34a prior to liquid working fluid 34a entering evaporator 28. Evaporator 28 utilizes heat source 36 to vaporize working fluid 34. In one example, heat source 36 can include hot oil heated with a biomass (i.e. tree) fueled burner.

Working fluid 34 exits evaporator 28 as a vapor (34b), and passes into turbine 30. Vaporized working fluid 34b is used to drive turbine 30, which in turn powers generator 32 such that generator 32 produces electrical power. High pressure vaporized working fluid 34b expands in turbine 30 and exits as a low temperature, low pressure vapor. After exiting turbine 30, working fluid 34b is cooled by recuperator 24. Finally, working fluid 34b returns to condenser 18 where it is condensed back to liquid 32a and the cycle is repeated. Heat sink 38 provides cooling to condenser 18. Although condenser 18 is shown generally as a heat exchanger, condenser 18 may be any condenser suitable for cooling and condensing working fluid vapor 34b back to working fluid liquid 34a. In one example, condenser 18 is an air-cooled condenser which uses air to cool and condense vapor working fluid 34b to liquid phase 34a. In another example, condenser 18 is a water-cooled condenser which uses water to cool and condense vapor 34b to liquid 34a.

As discussed above, recuperator 24 heats working fluid 34 before it enters evaporator 28 and cools working fluid 34 before it enters condenser 18. Recuperator 24 is a counterflow heat exchanger that uses waste heat recovered from the hotter vapor working fluid 34b to heat the cooler liquid working fluid 34a. Recuperator 24 conserves energy by recovering heat from working fluid 34b that otherwise would be lost. Under some operating conditions, recuperator 24 may not be present in ORC system 12. Recuperator 24 is generally present when working fluid 34b exits turbine 30 at a temperature much hotter then ambient temperature such that the superheated working fluid 34b must be cooled before entering condenser 18.

Electric heater 26 also heats working fluid 34a prior to working fluid 34a entering evaporator 28. As discussed further below, inverter system 14 diverts excess power to heater 26 so that a constant voltage is maintained regardless of increases or decreases in load 16. Heater 26 should be sized to receive the maximum power produced by turbine 30 and generator 32 so that the entire amount of power can be diverted to heater 26 if necessary, such as when the local grid trips. In one example, heat from heater 26 is equal to or less than approximately 10% of the total heat transferred to working fluid 34a by evaporator 28. Therefore, heater 26 does not significantly disrupt system 12.

The amount of power generated by ORC system 12 cannot be quickly changed. For example, as described above, heat source 36 to evaporator 28 can include hot oil that is heated by a burner and flows through evaporator 28 to vaporize working fluid 34. Controlling the flow of hot oil controls the temperature change of working fluid 34 in evaporator 28 and thus the amount of power generated. To decrease the temperature of working fluid 34 (and reduce the power generated by ORC system 12), the flow of hot oil to evaporator 28 is reduced. The reduced flow of hot oil causes the oil on the burner to increase in temperature. In response, the burn rate of the burner is decreased to reduce the temperature of the oil. However, the decreased flow rate of oil does not instantaneously change the generation of power. Ultimately, evaporator 28 and working fluid 34 must change temperature in order to reduce the amount of power generated. Thus, the actual time required to change the power generation of system 12 is not the time it takes to reduce the flow of hot oil to evaporator 28 but instead is the time it takes to cool evaporator 28 and working fluid 34. This time is on the magnitude of minutes because of the large thermal mass of working fluid 34 and the thermal capacitance of evaporator 28.

After power is generated by ORC system 12, it flows through inverter system 14 to load 16. Inverter system 14 includes AC/DC rectifier 40, direct current (DC) bus 42, DC/AC inverter 44, capacitor 46, battery 48 and voltage regulator 50. In use, electric power flows from AC/DC rectifier 40 through DC bus 42 and AC/DC inverter 44 to load 16. AC/DC rectifier 40 receives alternating current (AC) from generator 32 and converts it to direct current (DC). The DC current flows from AC/DC rectifier 40 through DC bus 42 to DC/AC inverter 44, which receives the DC current from DC bus 42 and converts it to AC current so that AC current is provided to load 16. DC bus 42 must be maintained at a near-constant voltage by having equal amounts of power flowing in and out.

Capacitor 46 and battery 48 are connected to DC bus 42. Capacitor 46 provides stability for DC bus 42 so that the power into and out of DC bus 42 does not have to be matched every fraction of a second. Capacitor 46 provides between about several milliseconds and one second for the system to respond to a change in load 16. Capacitor 46 does not provide the minutes of time required to adjust the amount of power generated by ORC system 12.

Battery 48 can be used during start up of ORC system 12. Battery 48 can be a rechargeable battery that is charged by power from DC bus 42 when excess power is available. Although battery 48 is illustrated as a single battery, battery 48 can include a plurality of batteries.

Voltage regulator 50 is located between AC/DC rectifier 40 and DC bus 42. As previously discussed, the power into and out of DC bus 42 must be matched to maintain the voltage on DC bus 42. Voltage regulator 50 diverts excess electric power flowing into DC bus 42 back to ORC system 12 so that the electric power flowing into DC bus 42 matches the electric power flowing out of DC bus 42. Specifically, voltage regulator 50 sends the excess electric power to heater 26, which uses the power to heat working fluid 34a before working fluid 34a enters evaporator 28. By heating the working fluid prior to evaporator 28, the heating rate of the evaporator may be reduced equally. Thus, the efficiency of the ORC system, which is defined as the power output divided by the external heat input, is improved.

Voltage regulator 50 controls the flow of power to heater 26 in order to maintain the voltage on DC bus 42. In one example, voltage regulator 50 controls the flow of power to heater 26 by electronically pulsing electric heater 26 on and off based on a sensed parameter. A duty cycle is the portion of time during which a device is operated or in an “active” state during a given period. For example, suppose a device operates for 0.1 seconds, is shut off for 0.9 seconds, operates for 0.1 seconds again, and so on. The device operates for one tenth of every second, or 1/10 of the one second period, and it has a duty cycle of 1/10, or 10 percent. Voltage regulator 50 can change the duty cycle of heater 26 by changing the duration heater 26 is active (or pulsed on) during a period. By changing the duty cycle of heater 26, voltage regulator 50 changes the amount of power sent to heater 26 and DC bus 42. For example, by increasing the amount of time heater 26 is pulsed on during a period (also referred to as firing a bigger duty), voltage regulator 50 increases the amount of power sent to heater 26 during the period and decreases the flow of power into DC bus 42. Similarly, by decreasing the amount of time heater 26 is pulsed on during a period (also referred to as firing a smaller duty), voltage regulator 50 decreases the amount of power sent to heater 26 during the period and increases the flow of power into DC bus 42.

Inverter system 14 uses a sensed parameter sent to voltage regulator 50 to maintain a constant voltage on DC 42 or to maintain the voltage of DC bus 42 within a specified range. Voltage regulator 50 responds to sensed parameter and balances the flow of power into and out of DC bus 42 within about several milliseconds to one second to maintain the voltage on DC bus 42. In one example, voltage regulator 50 monitors voltage V_{B} of DC bus 42 so that the voltage of DC bus 42 is maintained within a specified range. For example, if voltage V_{B} of DC bus 42 increases above a maximum voltage value (i.e. load 16 decreases), voltage regulator 50 will fire a bigger duty so that heater 26 is pulsed on for a longer time. This sends more power to heater 26 and less to DC bus 42. Similarly, if voltage V_{B} of DC bus 42 decreases below a minimum voltage value (i.e. load 16 increases), voltage regulator 50 will fire a lower duty so that heater 26 is pulsed on for a shorter time. This sends less power heater 26 and more power to DC bus 42.

In another example, the sensed parameter inputted to voltage regulator 50 is load power P_{L}, which is the power exiting inverter system 14. In this example, voltage regulator 50 can pulse heater 26 on and off inversely proportional to changes in load power P_{L} to maintain a constant voltage on DC bus 42. For example, if load power P_{L} increases (i.e. load 16 increases), voltage regulator 50 will fire a lower duty so that heater 26 is on for a shorter time and more power is sent to DC bus 42. Similarly, if load power P_{L} decreases, (i.e. load 16 decreases), voltage regulator 50 will fire a bigger duty so that heater 26 is pulsed on for a longer time and less power is sent to DC bus 42.

In a further example, the sensed parameter inputted to voltage regulator 50 includes load power P_{L} and input power P_{I}, which is the power entering DC bus 42. In this example, voltage regulator 50 can compare load power P_{L} and input power P_{I} to determine the amount of power to divert to heater 26. In a further example, voltage regulator 50 determines the amount of power diverted to heater 26 based on trends in the sensed parameter. Additionally, any other parameter suitable for determining the change in voltage of DC bus 42 can be a sensed parameter and sent to voltage regulator 50.

Voltage regulator 50 can include a switch and a controller. The switch of voltage regulator 50 controls the flow of power to electric heater 26. In one example, the switch is a gate turn-off thyristor (GTO). A GTO is a high-power semiconductor device. GTOs, as opposed to normal thyristors, are fully controllable switches which can be turned on and off by their third lead, the GATE lead. When current is removed from a GTO, the GTO turns off. The controller of voltage regulator 50 can include a processor for determining the amount of power to divert to electric heater 26 based upon the sensed parameter. The controller can also control the switch so that the determined amount of power is diverted to heater 26.

Voltage regulator 50 allows power generation system 10 to quickly react to negative and positive changes in load 16. For example, when load 16 decreases, voltage regulator 50 diverts the excess power to heater 26 and maintains the voltage on DC bus 42 within milliseconds or seconds. Voltage regulator 50 can continue diverting the excess power to heater 26 as long as necessary or voltage regulator 50 can enter a steady-state mode so that excess heat is not wasted and system 10 can accommodate a positive step change in load 16.

If load 16 increases, voltage regulator 50 will divert less power to heater 26 so that more power goes to load 16. In order for voltage regulator 50 to respond to a positive step in load 16, the step cannot be greater than the amount of power being diverted to heater 26 immediately prior to the positive step. To accommodate positive step changes in load 16, voltage regulator 50 can be configured to divert a buffer amount of power to electric heater 26. The buffer amount is a specified amount of power produced by ORC system 12 above the power required by load 16 and system 10. The buffer amount allows power generation system 10 to react to a positive step change. The size of the buffer amount can be varied depending on the site and the expected maximum positive step increase. Following a positive step change in load 16, voltage regulator 50 can either maintain the new equalized system or enter steady-state mode so that the specified buffer amount is again produced in anticipation of another positive step change.

The type of generator 32 used in ORC system 12 affects the type of rectifier 40 used in inverter system 14. In one example, generator 32 is an induction generator. An induction generator does not control frequency. Instead an induction generator follows the frequency that it sees. In this case, rectifier 40 must be a full bi-directional inverter, which controls and forces a frequency on induction generator 32.

In another example, generator 32 is a synchronous generator. In a synchronous generator, the frequency produced by the generator is fed back to it so that a synchronous generator generates its own frequency. When generator 32 is a synchronous generator, rectifier 40 is a rectifier.

In a further example, generator 32 is a permanent magnet generator. Similar to a synchronous generator, a permanent magnet generator also generates its own frequency. The spinning speed of the permanent magnet generator determines both the frequency and the voltage out of the generator. When permanent magnet generator 32 is used with simple rectifier 40, the frequency is held within a band defined by the generator power and the DC bus 42 voltage. If tighter frequency control is desired for generator 32 or turbine 30, then an active break inverter may be used for rectifier 40.

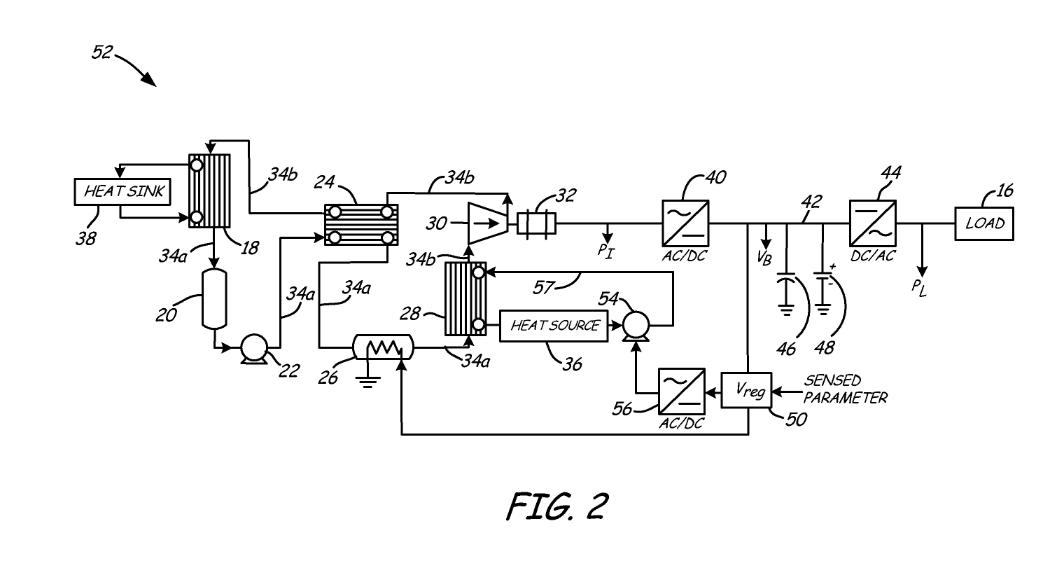

FIG. 2 is a block diagram of system 52, which is similar to power system 10 of FIG. 1 except voltage regulator 50 is also connected to pump 54 and inverter 56. Pump 54 pumps heating fluid 57 through the heating loop created between heat source 36 and evaporator 28. Inverter 56 converts the DC current from voltage regulator 50 to AC current for pump 54. Pump 54 is a parasitic load that takes power from DC bus 42. Voltage regulator 50 varies the amount of power sent to pump 54 to control the power generation of ORC system 12. To generate more power with ORC system 12, voltage regulator 50 sends more power to pump 54. The larger amount of power causes pump 54 to increase in speed, which increases the temperature of evaporator 28. Similarly, to decrease the amount of power generated by ORC system 12, voltage regulator 50 sends less power to pump 54, which causes pump 54 to decrease in speed. The decreased speed of pump 54 causes pump 54 to pump less fluid from heat source 36 to evaporator 28, and the temperature of evaporator 28 decreases. Pump 54 is one example of a parasitic load that can be present in the ORC system. Other parasitic loads include additional pumps and fans for the heating and cooling systems (i.e. evaporator 28, condenser 18), such as pump 22. These parasitic loads will operate in manner similar to pump 54 and will not affect the basic operation of voltage regulator 50. The remaining features of system 52 operate as described above with respect to FIG. 1.

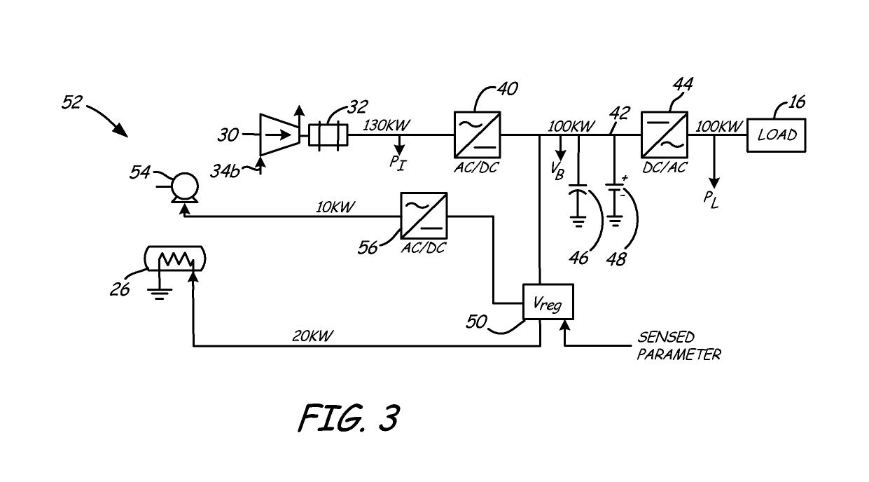

FIG. 3 through FIG. 7 are enlarged views of the system of FIG. 2 showing the electric power at selected points in system 52 following various events and under different conditions. In system 52 presented in FIG. 2-FIG. 7, ORC system 12 can produce up to 220 kW and DC bus 42 has a voltage of about 700 volts DC (VDC). Secondary losses, such as inverter conversion losses are ignored in the examples presented in FIG. 3-FIG. 7. Further, the power and voltage values in FIG. 3-FIG. 7 are only presented to illustrate the operation of voltage regulator 50 and the steady-state and stand-by modes. A power generation system can have power and voltage values different from those presented below.

FIG. 3 illustrates the ORC system 52 in steady-state mode. As illustrated, turbine 30 and generator 32 produce 130 kW of power and load 16 requires 100 kW. At steady state, heat pump 54 takes 10 kW. Without heater 26, 120 kW would enter DC bus 42. That is, without heater 26, 20 kW more power would flow in to DC bus 42 than would exit. Voltage regulator 50 diverts the 20 kW of excess power to heater 26 so that 100 kW enter DC bus 42 and 100 kW exit DC bus 42.

In steady-state mode, voltage regulator 50 diverts a buffer amount of power to electric heater 26. The buffer amount is a specified amount of power produced by ORC system 12 in excess of the power requirement of load 16 and heat pump 54. In the example illustrated in FIG. 3, the buffer amount is 20 kW. The buffer amount is the largest positive step amount ORC system 52 can accommodate without utilizing an alternative power source such as a gas generator. The specified size of the buffer amount depends on the maximum load step expected at a site. The benefits of configuring voltage regulator 50 to divert a buffer amount of power to electric heater 26 are further illustrated below.

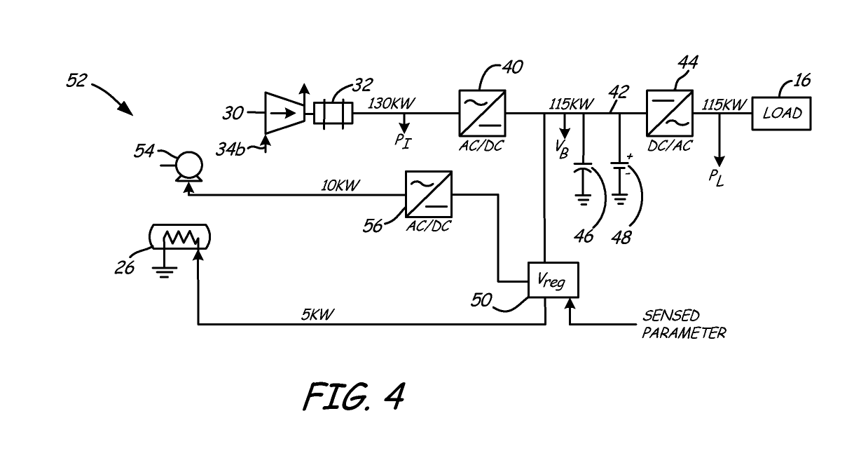

In FIG. 4, load 16 is suddenly increased by a positive step of 15 kW to 115 kW. Instantly, the power out of DC bus 42 is 15 kW greater than the power in to DC bus 42 and the voltage of DC bus 42 drops. Voltage regulator 50 responds to the drop in voltage by reducing the power to heater 26 to 5 kW so that the flow into and out of DC bus 42 is again equal at 115 kW, and the voltage of DC bus 42 is maintained. Following the positive step of 15 kW, a new equilibrium in system 52 is reached. Heat pump 54 receives the same amount of power (10 kW) as before the step change so that turbine 30 and generator 32 continue producing the same amount of power (130 kW). However, voltage regulator 50 has decreased the amount of power sent to heater 26 so that heater 26 now only receives 5 kW. The quick response of voltage regulator 50 balances the power into and out of DC bus 42 in less than one second. In maintaining the voltage of DC bus 42, voltage regulator 50 can return the voltage to 700 VDC or can leave the voltage slightly below 700 VDC as long as the voltage is within the range specified for the system.

In this example, voltage regulator 50 is able to decrease the amount of power diverted to heater 26 and meet the increased demand of load 16 because immediately before the step change voltage regulator 50 was diverting a buffer amount of power to ORC system 12. As described with respect to FIG. 3, before the step change, ORC system 12 was producing a buffer amount of 20 kW of excess power, which voltage regulator 50 diverted to electric heater 26. The buffer amount of power allowed system 52 to accommodate a positive increase in load 16.

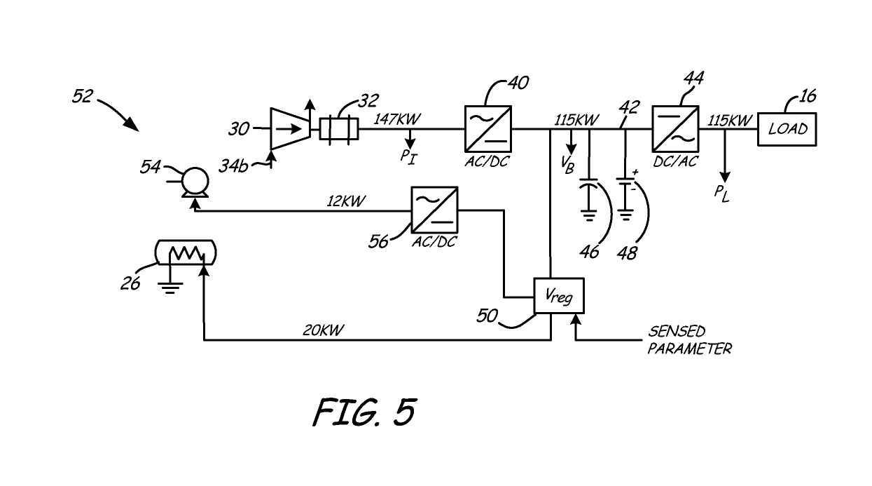

FIG. 4 shows system 52 immediately following a positive step change in load 16 while FIG. 5 shows system 52 in steady-state mode following the positive step change of 15 kW. In steady-state mode, voltage regulator 50 is configured to adjust the allocation of power to heat pump 54 so that a specified buffer amount of about 20 kW is again diverted to heater 26. Following a positive step change, ORC system 12 must generate more power so that voltage regulator 50 can divert the buffer amount of power to electric heater 26 while maintaining a constant voltage on DC bus 42. Voltage regulator 50 increases the power generation of ORC system 12 by increasing the power sent to heat pump 54. The increased amount of power sent to heat pump 54 increases the speed of pump 54, which in turn increases the temperature of evaporator 28 and the power generated by turbine 30 and generator 32. As shown in FIG. 5, voltage regulator 50 increases the power sent to heat pump 54 to 12 kW to increase the power generation of ORC system 12 to 147 kW. In steady-state mode with load 16 equal to 115 kW, voltage regulator 50 increases the power generated by turbine 30 and generator 32 to 147 kW; 12 kW of this power goes to heat pump 54, a buffer amount of 20 kW goes to heater 26 and 115 kW goes through DC bus 42 to load 16. A positive step change of 15 kW requires ORC system 12 to increase power generation by 17 kW because more power must be sent to heat pump 54 so that more heat is supplied to evaporator 28. In steady-state mode, voltage regulator 50 diverts a buffer amount of power to heater 26. The buffer amount is the amount of power generated in excess of the demand of heat pump 54 and load 16. If there is a positive step change in load 16, up to the entire buffer amount can be diverted from heater 26 to load 16 to balance the power flows into and out of DC bus 42. In steady-state mode, system 52 can accommodate a positive step change up to 20 kW.

Immediately following a positive step change in load 16, voltage regulator 50 maintains the voltage of DC bus 42 within a specified range by diverting less power to heater 26. If desired, voltage regulator 50 can adjust the power generated by ORC system 12 to accommodate this positive step change and return system 52 to steady-state mode. For example, voltage regulator 50 can increase the power sent to heat pump 54 which increases the heat impute to evaporator 28. In steady-state mode, a specified excess amount of power is generated (also known as a buffer amount) which allows system 52 to respond to future positive step changes in load 16. Diverting power from electric heater 26 to load 16 with voltage regulator 50 provides a quick response to a positive step increase in load 16, and balances the power into and out of DC bus 42 within the milliseconds to one second allotted timeframe. In contrast, it takes minutes to adjust the amount of power generated by ORC system 12 because of the large thermal mass of working fluid 34, and the power into and out of DC bus 42 cannot be balanced within the allotted timeframe. Diverting power from electric heater 26 to load 16 with voltage regulator 50 allows power system 52 to respond to a positive load change.

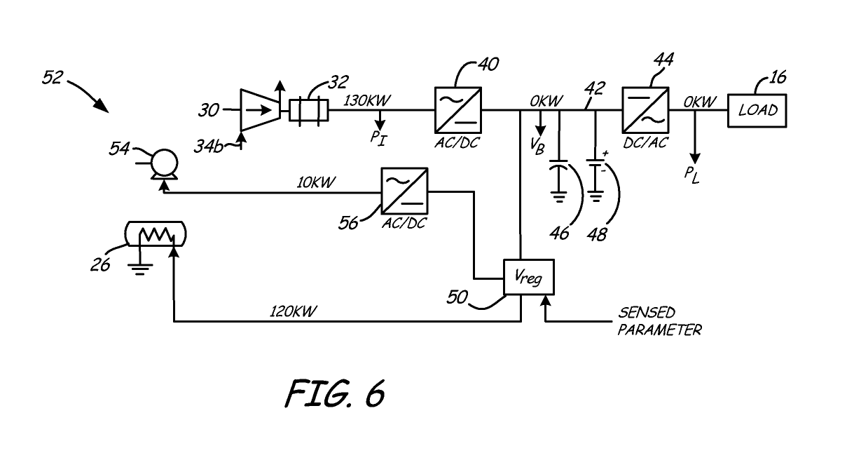

FIG. 6 shows ORC power generation system 52 immediately following a negative step in load 16 to 0 kW. Prior to the negative step change, system 52 was operating under the conditions presented in FIG. 3 and load 16 was 100 kW. A negative step change to 0 kW can occur, for example, when the local grid trips. Instantly following the negative step change, the power into DC bus 42 is 100 kW greater than the power out of DC bus 42. This unmatched flow of power causes the voltage of DC bus 42 to increase. Voltage regulator 50 responds to the increased voltage by sending more power to heater 26. ORC power generation system 52 continues to generate the same amount of power as before the negative step change, with the excess power being diverted to heater 26. As illustrated, immediately following the negative step, heat pump 54 continues to receive 10 kW so that turbine 30 and generator 32 continue to produce 130 kW. Voltage regulator 50 diverts the excess power flowing into DC bus 42 to heater 26 so that the remaining 120 kW now flow to heater 26. Voltage regulator 50 allows ORC power generation system 52 to react to a momentary decrease in load without losing the efficiency achieved during operation. After building the pressure and temperature in ORC system 52, it is not desirable to unnecessarily shut down or reduce the amount of power generated by ORC system 12. Stopping or reducing the amount power generated by ORC system 12 wastes the energy consumed to reach the current temperature and pressure of ORC system 12. Further, when the load again increases or the grid is restored, extra time will be consumed to again increase the temperature and pressure of ORC system 12 because of the thermal mass of working fluid 34 and capacitance of the heat exchangers 18, 24 and 28. However, if the temperature and pressure of ORC system 12 is maintained following a negative step change, ORC system 12 is ready to provide power immediately upon reconnection to the local grid.

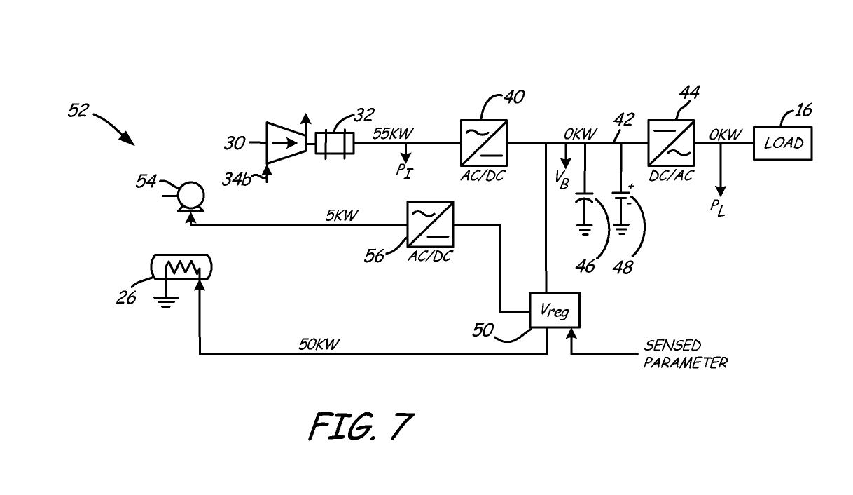

The system of FIG. 6 can be used immediately following a negative step change or if the negative step change is for a short time period. If ORC system 12 is disconnected from the local grid for a significant period of time, ORC system 52 can enter stand-by mode and wait for re-connection to the local grid. FIG. 7 shows system 52 in stand-by mode following the negative step change described in FIG. 6. In stand-by mode, voltage regulator 50 decreases the power produced by turbine 30 and generator 32 by reducing the power to heat pump 54. With less power, heat pump 54 pumps less heat to evaporator 28, thus decreasing the temperature of working fluid 34. Because less power is generated by turbine 30 and generator 32, there is less excess heat flowing into DC bus 42 and less power must be diverted to heater 26. In stand-by mode, a specified minimum amount of power is sent to heater 26. In system 52, the minimum amount is 50 kW. This minimum amount of power represents the largest allowable step increase in load when the grid comes back on-line. Overall, ORC system 12 produces 55 kW; 5 kW go to heat pump 54 and the remaining 50 kW go to heater 26. By maintaining system 52 in stand-by mode, system 52 can more quickly respond to a positive step change once re-connected to the grid. For example, by keeping working fluid 34 at a minimum temperature, system 52 can accommodate a step change equal up to the minimum amount upon reconnection to the grid. The stand-by mode prevents lag time between reconnection to the grid and power generation by system 52. The size of the minimum amount of power can be varied depending on the site. In both stand-by mode and steady-state mode, excess power is generated and diverted to heater 26. The amount of excess power generated for steady-state mode and stand-by mode can be the same or can be different depending on the expected load changes under the specific circumstances.

When load 16 is greater than 0 kW and system 52 is in steady-state mode, ORC system 12 continuously generates and voltage regulator 50 diverts a buffer amount of extra power in excess of the power requirements of load 16 and heat pump 54. This buffer amount allows system 52 and voltage regulator 50 to quickly respond to positive step changes in load 16 and maintain a constant voltage on DC bus 42. In use, voltage regulator 50 diverts the excess power back to heater 26. Heater 26 uses the power to preheat working fluid 34a. Pre-heating working fluid 34 reduces the required heat input to evaporator 28. Therefore, the excess power generated for the buffer amount is not a complete inefficiency. Further, in one example the heat from heater 26 is at most equal to approximately 10% of the total heat provided by evaporator 28 so that heater 26 does not significantly perturb or disrupt ORC system 12. The size of the buffer amount diverted by voltage regulator 50 will depend on the maximum step load increase expected for a site.

When load 16 is 0 kW and system 52 is in stand-by mode, ORC system 12 generates and voltage regulator 50 diverts a minimum amount of power in excess of the power requirements of load 16 and heat pump 54 so that ORC system 12 is not stopped. This minimum amount is the maximum step change allowed when the system re-connects to the local grid or load 16 is increased from 0 kW. The diversion of the minimum amount to heater 26 prevents a delay in power generation by ORC system 12 once the connection to the grid is re-established. Similar to the buffer, the excess power generated in the stand-by mode is diverted by voltage regulator 50 to heater 26 to pre-heat working fluid 34a. Pre-heating working fluid 34a reduces the input heat necessary to evaporator 28 while maintaining working fluid 34a at a minimum temperature. Additionally, heater 26 does not significantly disrupt ORC system 12 because the heat from heater 26 is at most equal to about 10% of the total heat provided by evaporator 28. The specified value for the minimum amount of power diverted to heater 26 in stand-by mode will depend on the maximum step change experienced when re-connecting to the grid and will vary depending on the site.

As described above, the generation of power in ORC system 12 cannot be quickly changed so as to be load-following because of the large thermal mass of working fluid 34 and heat exchangers 18, 24 and 28. In stand alone systems or ORC systems connected to a local or island grid, the power into and out of the DC bus must be equalized within about milliseconds to one second. Voltage regulator 50 can redirect power between load 16 and electric heater 26 to balance the power into and out of DC bus 42 within the about milliseconds to about one second timeframe. Further, by generating excess power in ORC system 12 which is diverted back to heater 26, voltage regulator 50 and power generation system 52 can quickly respond to positive step increase in load 16. Thus, ORC system 12 can be used in locations where an infinite grid is not available.

System 52 described in FIG. 3-FIG. 7, which produces a buffer amount in steady-state mode and a minimum amount in stand-by mode, is best suited for an ORC system where the heat source to evaporator 28 is not completely free, such as a biomass heat source. Because of heat source cost concerns, it is not desirable to unnecessarily continuously run such systems at maximum power production. To reduce costs, the heat input to evaporator 28 is reduced when the extra power is not necessary, such as when the system enters steady-state mode and stand-by mode. System 52 is configured to produce a buffer amount of 20 kW when load 16 is greater than 0 kW and a minimum amount of 50 kW when the load is 0 kW. The buffer amount represents the largest allowable step increase of load 16 when system 52 is connected to a local grid. The minimum amount represents the largest allowable step increase in load 16 when reconnecting system 52 to a local grid. The buffer amount and the minimum amount can be adjusted based on the particular requirements of a site.

If the heat input to evaporator 28 is free, such as geothermal heat, it may be desirable to continuously run system 52 at maximum power. In this case, voltage regulator 50 still diverts power to and from heater 26 as described above but system 52 would not enter the steady-state mode or the stand-by mode. If system 12 is continuously run at maximum power generation, the pressure of system 12 should be monitored because such operation can increase the pressure of ORC system 12 above the designed pressure. If, for example, half of the power generated by turbine 30 and generator 32 is diverted back to heater 26 and the heat input to evaporator 28 remains constant, ORC system 12 will continually produce more power. Eventually the pressure limit of system 12 can be reached and system 12 becomes overstressed. Monitoring the pressure of system 12 allows the operating conditions of system 12 to be adjusted to reduce the pressure of system 12 before the pressure limit of system 12 is exceeded.

As mentioned above, other parasitic loads can exist in system 52 in addition to or in place of pump 54. In one example, pump 22 and pump 54 are both parasitic loads. Pump 22 pumps liquid working fluid or refrigerant to heat exchanger 24. The power requirements of pump 22 generally follow the same trend as the power requirements of pump 54. That is, when the power requirements of pump 54 increase, the power requirements of pump 22 also increase. A system containing parasitic pumps 22 and 54 operates in the same manner as system 52 described above. The only difference is that power from taken from DC bus 42 must be distributed between pumps 22 and 54.

While the invention has been described with reference to an exemplary embodiment(s), it will be understood by those skilled in the art that various changes may be made and equivalents may be substituted for elements thereof without departing from the scope of the invention. For example, a power generation system may operate in steady-state mode when the load is greater than 0 kW but the ORC system may stop when the load is less than 0 kW (the power generation system does not operate in a stand-by mode). In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system for producing power using an organic Rankine cycle (ORC), the system comprising:
a turbine coupled to a generator for producing electric power;
an evaporator upstream of the turbine for providing a vaporized organic fluid to the turbine;
an electric heater upstream of the evaporator for heating the organic fluid prior to the evaporator;
an inverter system coupled to the generator for transferring electric power from the generator to a load; and
an organic Rankine cycle (ORC) voltage regulator coupled to the inverter system and coupled to the electric heater for diverting excess electric power from the inverter system to the electric heater.

2. The system of claim 1, wherein the ORC voltage regulator comprises a switch.

3. The system of claim 1, wherein the generator is an induction generator and the inverter system comprises a bi-directional inverter.

4. The system of claim 1, wherein the generator is selected from the group consisting of a permanent magnet generator and a synchronous generator.

5. The system of claim 1, and further comprising a parasitic load connected to the inverter system.

6. The system of claim 1, wherein the inverter system comprises a battery.

7. The system of claim 1, wherein the ORC voltage regulator is configured to divert a minimum amount of electric power to the heater when a load is equal to 0 kW.

8. The system of claim 1, wherein the ORC voltage regulator is configured to divert a buffer amount of electric power to the heater when the load is greater than 0 kW.

9. The system of claim 1, wherein the ORC voltage regulator is configured to reduce a heat input to the evaporator when there is an increase in the excess power diverted to the heater.

10. The system of claim 1, wherein the ORC voltage regulator is configured to increase a heat input to the evaporator when there is a decrease in the excess power diverted to the heater.

11. The system of claim 1, and further comprising a local grid connected to the inverter system.

12. A method of producing load-following electrical energy using an organic Rankine cycle (ORC) system, the method comprising:
producing electric power with an organic Rankine cycle (ORC) system by evaporating an organic fluid, passing the evaporated organic fluid through a turbine coupled to a generator, condensing the organic fluid and returning the condensed organic fluid to the evaporator;
sending the electric power from the ORC system through a DC bus to a load; and
using a voltage regulator to send excess electric power flowing into the DC bus to the ORC system so that the electric power flowing into the DC bus matches the electric power flowing out of the DC bus.

13. The method of claim 12, wherein the voltage regulator sends the excess electric power flowing into the DC bus to an electric heater in the ORC system.

14. The method of claim 13, and further comprising reducing heat input to the evaporator when the excess electric power sent to the electric heater increases.

15. The method of claim 13, and further comprising increasing heat input to the evaporator when the excess electric power sent to the electric heater decreases.

16. The method of claim 12, wherein the voltage regulator uses a switch to send the excess electric power flowing into the DC bus to the ORC system.

17. The method of claim 12, and further comprising storing a selected portion of electric power in a battery.

18. The method of claim 12, wherein maintaining the voltage in the DC bus comprises:
comparing a voltage of the DC bus to a maximum voltage and a minimum voltage; and
increasing the amount of electric power sent to the ORC system by the voltage regulator if the voltage is higher than the maximum voltage and decreasing the amount of electric power sent to the ORC system by the voltage regulator if the voltage is lower than the minimum voltage.

19. The method of claim 12, wherein the voltage regulator sends the ORC system a specified minimum amount of power when the load is about 0 kW.

20. The method of claim 12, wherein the voltage regulator sends the ORC system a specified buffer amount of power when the load is greater than about 0 kW.
